(19) United States
(12) Patent Application Publication
(10) Pub. No.: US 2026/0181511 A1
(43) Pub. Date: Jun. 25, 2026

(54) TRACKING AREA UPDATE METHOD AND WIRELESS COMMUNICATION DEVICE

(71) Applicant: Samsung Electronics Co., Ltd., Suwon-si, Gyeonggi-do (KR)

(72) Inventors: Fanhua KONG, Beijing (CN); Weiwei WANG, Beijing (CN); Hong WANG, Beijing (CN); Lixiang XU, Beijing (CN)

(21) Appl. No.: 19/126,473

(22) PCT Filed: Oct. 23, 2023
(86) PCT No.: PCT/KR2023/016500

§ 371 Date: May 1, 2025

(30) Foreign Application Priority Data
Nov. 2, 2022 (CN) 202211364885.4

(51) Int. Cl. H04W 36/32; H04W 68/02; H04W 88/16

(52) U.S. Cl. CPC H04W 36/322; H04W 68/02; H04W 88/16

(57) ABSTRACT

The disclosure relates to a 5G or 6G communication system for supporting a higher data transmission rate. A method performed by a first node in a wireless communication system is disclosed. The method includes: receiving, from a fourth node, migration request related information, wherein the fourth node is connected to a mobile integrated access and backhaul (IAB) node; in response to the migration request related information, transmitting, to the fourth node, migration response related information; and transmitting, to the mobile IAB node, tracking area update (TAU) related information, wherein the TAU related information comprises information indicating not to perform TAU.

### TECHNICAL FIELD

The present disclosure relates to a field of wireless communication technology, and more particularly, to a method for tracking area update (TAU) and a wireless communication device.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem

The purpose of this application is to be able to solve at least one of the drawbacks of the prior art. The present application provides improved tracking area update (TAU) method node to solve the problem of degradation in wireless communication.

### Solution to Problem

Aspects and advantages of embodiments of the present disclosure will be set forth in part in the following description, or may be learned from the description, or may be learned by practice of the embodiments.

The present application provides a method for tracking area update and a wireless communication device.

In order to achieve the above objective, the application adopts technical solutions below:

According to one aspect of the embodiments of the present disclosure, there is provided a method performed by a first node in a wireless communication system. The method includes: receiving, by the first node, tracking area related information associated with a cell of a mobile integrated access and backhaul (IAB) node associated with the first node from a second node; and transmitting the tracking area related information to a third node.

According to an exemplary embodiment, the method further includes: sending, by the first node, a first message to the mobile IAB node, wherein, the first message includes the tracking area related information and the cell related information.

According to an exemplary embodiment, the method further includes: receiving candidate tracking area related information configured by the second node, and determining the tracking area related information according to the candidate tracking area related information; or sending, by the first node, a message for requesting the tracking area related information from the second node.

According to an exemplary embodiment, the tracking area related information is transmitted by the second node to a neighbor node of the first node.

According to another aspect of the embodiments of the present disclosure, there is provided a method performed by a third node in a wireless communication system. The method includes: receiving, by the third node, tracking area related information associated with a cell of a mobile integrated access and backhaul (IAB) node associated with a first node from the first node; and transmitting, by the third node, tracking area identification code list related information including the tracking area related information to a user equipment (UE) in the cell.

According to another aspect of the embodiments of the present disclosure, there is provided a method performed by a first node in a wireless communication system. The method includes: receiving, by the first node, migration request related information from a fourth node to which a mobile integrated access and backhaul (IAB) node is connected; in response to the migration request related information, transmitting, by the first node, migration response related information to the fourth node; and transmitting, by the first node, tracking area update (TAU) related information to the mobile IAB node, wherein, the TAU related information includes information indicating not to perform TAU.

According to an exemplary embodiment, the method further includes: receiving, by the first node, first-type user equipment (UE) list related information associated with the mobile IAB node from the mobile IAB node; and transmitting, by the first node, the first-type UE list related information to the third node.

According to another aspect of embodiments of the present disclosure, there is provided a method performed by a mobile integrated access and backhaul (IAB) node in a wireless communication system. The method includes: receiving, by the mobile IAB node, tracking area update (TAU) related information from a first node, wherein, the TAU related information includes information indicating not to perform TAU; and transmitting, by the mobile IAB node, the TAU related information to a user equipment (UE).

According to an exemplary embodiment, the TAU related information is carried in a system information block (SIB), and the TAU related information further includes type-related information of UE that does not perform TAU; or the TAU related information is carried in a radio resource control (RRC) message.

According to an exemplary embodiment, the TAU related information further includes a timer, and the UE does not perform TAU within time of the timer.

According to an exemplary embodiment, the method further includes: transmitting, by the mobile IAB node, first-type UE list related information associated with the mobile IAB node to the first node.

According to an exemplary embodiment, the method further includes: updating, by the mobile IAB node, the first-type UE list related information, and transmitting the updated first-type UE list related information to a third node via the first node.

According to an exemplary embodiment, when the UE in connected state is not a UE of a first type, the mobile IAB node updates the first-type UE list related information.

According to an exemplary embodiment, the method further includes: receiving, by the mobile IAB node, a paging message for paging a UE in the first-type UE list related information from the third node or other nodes in communication with the third node; and sending, by the mobile IAB node, the paging message to the UE.

According to another aspect of the embodiments of the present disclosure, there is provided a method performed by a user equipment (UE) in a wireless communication system. The method includes: receiving, by the UE, tracking area update (TAU) related information from a mobile integrated access and backhaul (IAB) node, wherein, the TAU related information includes information indicating not to perform TAU, and not performing TAU by the UE, based on the TAU related information.

According to an exemplary embodiment, the TAU related information is carried in a system information block (SIB), and the TAU related information further includes type-related information of UE that does not perform TAU; or the TAU related information is carried in a radio resource control (RRC) message.

According to an exemplary embodiment, the TAU related information further includes a timer, and the UE does not perform TAU within time of the timer, wherein, the method further includes resuming TAU by the UE when the timer expires.

According to an exemplary embodiment, the method further includes: in response to receiving information indicating to resume TAU, resuming the TAU by the UE.

According to an exemplary embodiment, when the UE accesses the mobile IAB node, if the UE receives tracking area related information broadcast by the mobile IAB node and the tracking area related information is not included in tracking area identification code list related information configured by the third node, the UE performs TAU.

According to an exemplary embodiment, after performing TAU, the UE does not perform TAU based on the TAU related information received from the mobile IAB node.

According to another aspect of the embodiments of the present disclosure, there is provided a method performed by a third node in a wireless communication system. The method includes: receiving, by the third node, first-type user equipment (UE) list related information from a first node; and sending, by the third node, a paging message for paging a UE in the first-type UE list related information to a mobile integrated access and backhaul (IAB) node.

According to an exemplary embodiment, the method further includes: when the mobile IAB node moves from the third node to a fifth node, transmitting, by the third node, the first-type UE list related information to the fifth node, wherein, the first-type UE list related information is used by the fifth node for paging a UE in a cell of the mobile IAB node.

According to an exemplary embodiment, the method further includes: when a idle UE is not a UE of a first type, if the idle UE determines that the tracking area related information broadcast by the cell where it camps on is not included in tracking area identification code list related information configured by the third node, updating, by the third node, the first-type UE list related information based on the TAU initiated by the idle UE.

According to another aspect of the embodiments of the present disclosure, there is provided a wireless communication device, including a transceiver and a controller, where the controller is coupled to the transceiver and configured to perform any one of the foregoing methods.

The above and other features, aspects and advantages of various embodiments of the present disclosure will be better understood with reference to the following description and appended claims. The accompanying drawings, which constitute a part of this disclosure, illustrate exemplary embodiments of the disclosure and, together with the description, serve to explain related principles. The details of one or more imple-mentations of the inventive subject matter are set forth in the accompanying drawings and the description below. Other potential features, aspects, and advantages of the subject matter of the present disclosure will also become apparent from the description, drawings, and claims.

### Advantageous Effects of Invention

Embodiments of the present disclosure provides methods and apparatus for performing improved tracking area update (TAU) method to reduce signaling overhead.

### BRIEF DESCRIPTION OF DRAWINGS

The present disclosure will be better understood from the following detailed description with resort to the accompanying drawings, in which:

FIG. 1 is an example of system architecture evolution.

FIG. 2 is an example of 5G system architecture.

FIG. 3 is an example of a structure of a base station.

FIG. 4 is a flowchart illustrating an example of a TAU process induced by movement of a mobile IAB node according to an embodiment of the present disclosure.

FIG. 5 is a diagram illustrating an example of a method for tracking area update in a wireless communication system according to an embodiment of the present disclosure.

FIG. 6 is a flowchart illustrating an example of configuring a dedicated tracking area code (TAC) for a cell of a mobile IAB node according to an embodiment of the present disclosure.

FIG. 7 is a diagram illustrating another example of a method for tracking area update in a wireless communication system according to an embodiment of the present disclosure.

FIG. 8 is a flowchart illustrating an example of a mobile IAB node transmitting indication information to a UE according to an embodiment of the present disclosure.

FIG. 9 is a flowchart illustrating an example of a mobile IAB node/IAB donor CU transmitting indication information to an AMF according to an embodiment of the present disclosure.

FIG. 10 is a flowchart illustrating an example in which an AMF informs another AMF of a list according to an embodiment of the present disclosure.

FIG. 11 is a block diagram illustrating a wireless communication device according to an embodiment of the present disclosure.

In the various drawings, the same or similar reference signs and numerals designate the same or similar elements.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

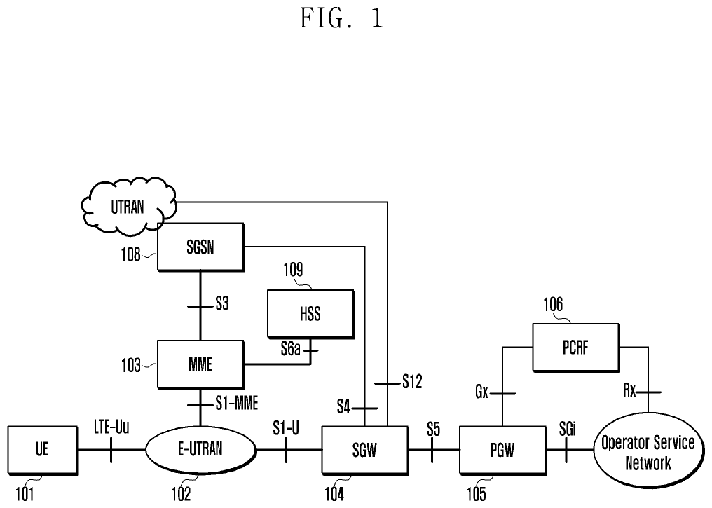

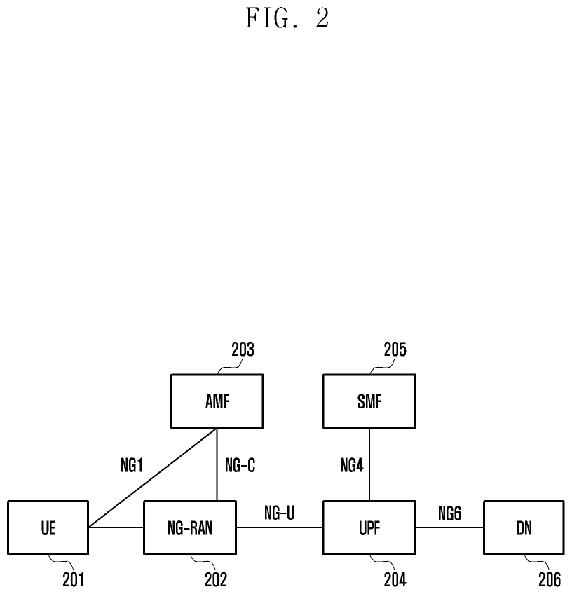

FIGS. 1 to 2 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommu-nications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

In a 5G communication technology, it has a faster transmission speed than 4G, because higher frequency is used; but the higher frequency also leads to shorter transmission distances, so more base stations will be deployed in the 5G communication network to ensure coverage of the 5G communication network. In fact, however, normal 5G base stations cannot be deployed in some areas due to envi-ronmental or cost reasons, so an integrated access and backhaul (IAB) technology is proposed to make up for the problem that 5G base stations cannot cover these areas, thus ensuring normal communication of users. The process of IAB network setup, partial migration, and data packet transmission in the IAB network has been determined, and research will be carried out on mobile IAB nodes and full migration.

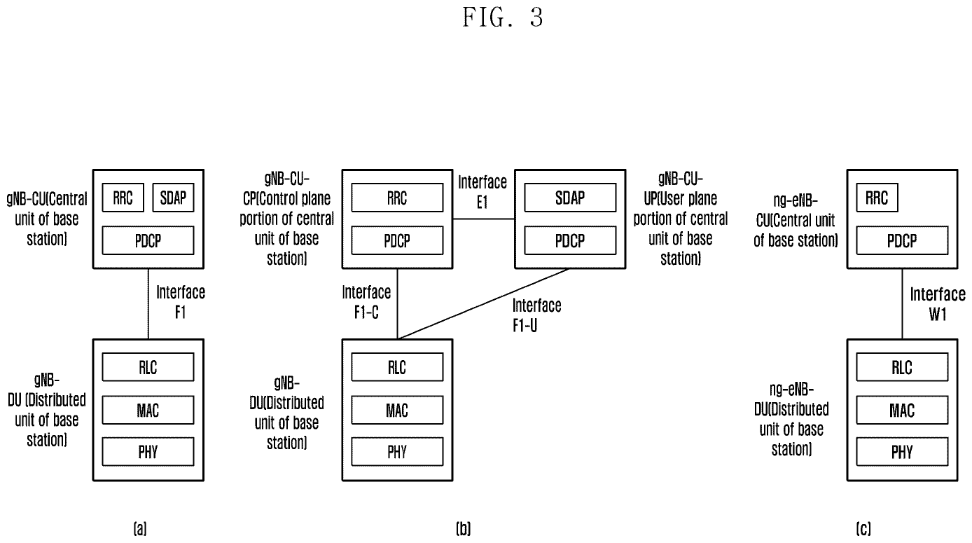

FIG. 3 is a diagram illustrating an example of a structure of a base station.

In an NR system, in order to support network function virtualization and more efficient resource management and scheduling, the base station (gNB/ng-eNB) that provides a wireless network interface for a terminal (user equipment (UE)) can be further divided into a gNB central unit/ng-eNB central unit (gNB-CU/ng-eNB-CU) and a gNB distributed unit/ng-eNB distributed unit (gNB-DU/ng-eNB-DU) (respectively referred to as CU and DU in the present disclosure), as shown in FIG. 3(a). gNB-CU has radio resource control (RRC), service data adaptation protocol (SDAP) and packet data convergence protocol (PDCP) layers, etc., and ng-eNB-CU has RRC, PDCP layers. gNB-DU/ng-eNB-DU has radio link control (RLC) protocol, media access control (MAC) and physical layer (PHY), etc. There is a standardized public interface F1 between gNB-CU and gNB-DU, and a standardized public interface W1 between ng-eNB-CU and ng-eNB-DU. The interface F1 includes an interface F1 for a control plane, F1-C, and an interface F1 for a user plane, F1-U. A transport network layer of F1-C is based on IP transmission. In order to transmit signaling more reliably, the SCTP protocol is added on top of IP. A protocol of the application layer is F1AP, for example, see 3GPP TS38.473. SCTP can provide reliable transmission of messages on the application layer. The transport layer of F1-U is UDP/IP, and GTP-U is used to carry user plane protocol data unit (PDU) on top of UDP/IP. Further, for gNB-CU, as shown in FIG. 3(b), gNB-CU may include gNB-CU-CP (a control plane portion of the central unit of the base station) and gNB-CU-UP (a user plane portion of the central unit of the base station), wherein, gNB-CU-CP includes the functions of the control plane of the base station and has RRC and PDCP layers, while gNB-CU-UP includes the functions of the user plane of the base station and has SDAP and PDCP layers. There is a standardized public interface E1 between gNB-CU-CP and gNB-CU-UP, and the protocol is E1AP, for example, see 3GPP TS38.463. An interface between the control plane portion of the central unit of the base station and the distributed unit of the base station is the interface F1-C, i.e., the control plane interface of F1, and an interface between the user plane portion of the central unit of the base station and the distributed unit of the base station is the interface F1-U, i.e., the user plane interface of F1. In addition, in the NR system, the base station that accesses the 5G core network and provides E-UTRA user plane and control plane is referred to as ng-eNB. In order to support virtualization, this base station (ng-eNB) can also be further divided a gNB central unit/ng-eNB central unit (ng-eNB-CU) and a gNB distributed unit/ng-eNB distributed unit (ng-eNB-DU) (abbreviated as CU and DU in the present disclosure), as shown in FIG. 3(c). ng-eNB-CU has RRC and PDCP layers. gNB-DU/ng-eNB-DU has radio link control protocol (RLC), media access control (MAC) and physical layer, etc. There is a standardized public interface W1 between ng-eNB-CU and ng-eNB-DU. The interface W1 includes an interface W1 for the control plane, W1-C, and an interface W1 for the user plane, W1-U. A transport network layer of W1-C is based on IP transmission. In order to transmit signalling more reliably, the SCTP protocol is added on top of IP. A protocol of the application layer may be W1AP, for example, see 3GPP TS37.473. The transport layer of W1-U is UDP/IP, and GTP-U is used to carry user plane protocol data unit (PDU) on top of UDP/IP.

In the previous research, the IAB node was considered to be fixed, so when a migrating node encounters degradation of wireless performance, a source IAB donor CU can perform partial migration according to a measurement report reported by the migrating node, to migrate the RRC signalling part of the migrating node to a target path; however, because research is going to be carried out on IAB nodes with mobility at this stage, the problem of degradation in wireless communication performance may not be solved well only through the original partial migration, and it may also be necessary to migrate the F1 connection to the target path, that is, migrate the F1 ter-mination of the migrating node DU on the source IAB donor CU to the target IAB donor CU. At this time, the mobile IAB node performs a full migration, that is, both a mobile IAB-MT and a mobile IAB-DU migrate to the target IAB donor CU.

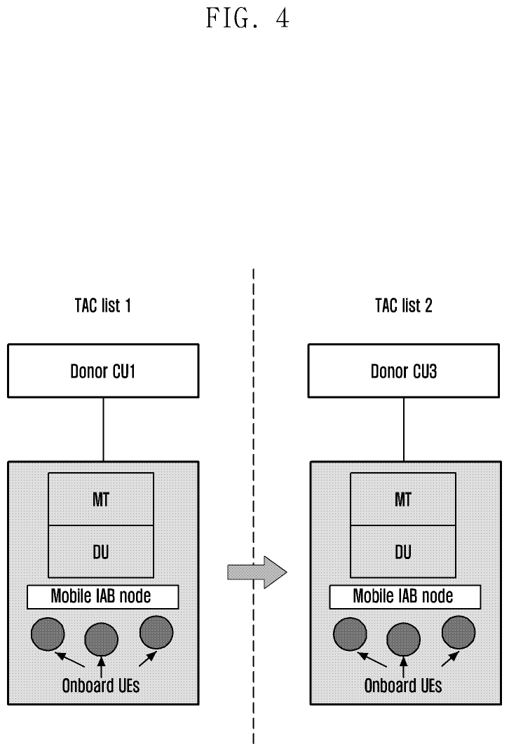

FIG. 4 is a flowchart illustrating an example of a TAU process induced by movement of a mobile IAB node according to an embodiment of the present disclosure.

As shown in FIG. 4, when the mobile IAB node moves, if both the mobile IAB-MT and the mobile IAB-DU of the mobile IAB node migrate from the IAB donor CU1 to the IAB donor CU3:
If the mobile IAB-MT receives that a TAC broadcast by a serving cell is not in a TAC list configured by AMF for the mobile IAB-MT, the mobile IAB-MT performs the TAU process;
If the mobile IAB node performs a full migration during the moving process, because the IAB donor CU has changed, configuration information of the mobile IAB-DU will also change, and the TAC broadcast by the cell of the IAB-DU will also change. If the TAC received by the UE served by the mobile IAB node is not in the TAC list configured by the AMF, the UE will also perform TAU at this time; when the number of UEs is large, it will cause a problem of generating a large amount of signalling overhead in a short time.

Therefore, there is a need for an improved TAU method to reduce signaling overhead.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

Before specific contents are illustrated, some assumptions and some definitions of the present disclosure are given out below.
Message names in the present disclosure are merely examples, and may also use other message names.
Words such as “first” and “second” included in the message names of the present disclosure are merely examples of messages, but do not denote any execution order.
In the present disclosure, the detailed description of steps irrelevant to the present disclosure is omitted.
In the present disclosure, the step in each flow may be combined with each other for execution, or may be executed separately. The execution order of steps in each flow is merely exemplary, not exclusive of other possible execution orders.
In the present disclosure, a base station may be a 5G base station (such as gNB, ng-eNB), or may be a 4G base station (such as eNB), or may be a 6G base station, or may be other types of access nodes.
In the present disclosure, the transmission of data refers to reception and/or transmission of data.

According to the embodiment of the present disclosure, a dedicated TAC within an area can be configured for a cell of the mobile IAB-DU. Generally, when the mobile IAB node moves to a new IAB donor CU, the new IAB donor CU can reconfigure the cell of the mobile IAB-DU. Therefore, the TAC broadcast by the cell of the mobile IAB-DU may change, when the mobile IAB node moves to a new IAB donor CU. If the TAC changes and the broadcast TAC is not in the TAC list configured by the AMF for the UE, the UE may perform TAU. Therefore, as an exemplary embodiment, a dedicated TAC in an area can be configured for the cell of the mobile IAB-DU. At this time, when the mobile IAB node moves in this area, the broadcast dedicated TAC will not change, then the UE does not frequently perform TAU either. With this embodiment, the signalling overhead caused by frequent TAU performed by a large number of UEs can be reduced to a certain extent.

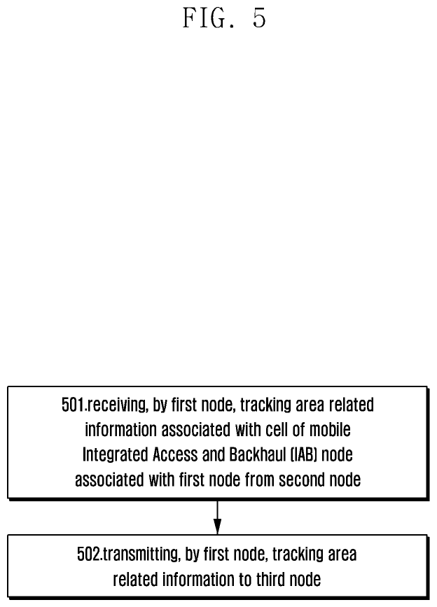

FIG. 5 is a diagram illustrating an example of a method for tracking area update in a wireless communication system according to an embodiment of the present disclosure. According to an exemplary embodiment, the first node may be a target IAB donor, the second node may be an OAM, and the third node may be an AMF. However, these are just examples, and the first to third nodes here are not limited thereto.

As shown in FIG. 5, the method may include but not limited to at least one of the following steps:

In step 501, the first node receives tracking area related information associated with a cell of a mobile integrated access and backhaul (IAB) node associated with the first node from the second node.

In step 502, the first node transmits the tracking area related information to the third node.

In an exemplary embodiment, the first node sends a first message to the mobile IAB node, wherein the first message includes tracking area related information and cell related information.

For example, the cell related information may include relevant information such as a cell identifier or a cell ID. The tracking area related information has a mapping relationship with the cell, that is, the tracking area related information is used for the corresponding cell.

In an exemplary embodiment, the method may further include: receiving, by the first node, candidate tracking area related information configured by the second node, and determining the tracking area related information according to the candidate tracking area related information; or sending, by the first node, a message for requesting the tracking area related information to the second node.

In an exemplary embodiment, the tracking area related information is transmitted by the second node to one or more neighbor nodes of the first node.

In this embodiment, the first node receives from the second node the tracking area related information associated with the cell of the mobile integrated access and backhaul (IAB) node associated with the first node, and transmits the tracking area related information to the third node, and the third node can configure the UE with a TAI list containing a dedicated TAC. Therefore, when the mobile IAB node moves within a certain area, the UE can always detect the tracking area related information in the TAC broadcast by the cell, and since the tracking area related information is included in the tracking area identification code list related information, the UE will not perform TAU, thereby reducing the corresponding signalling overhead.

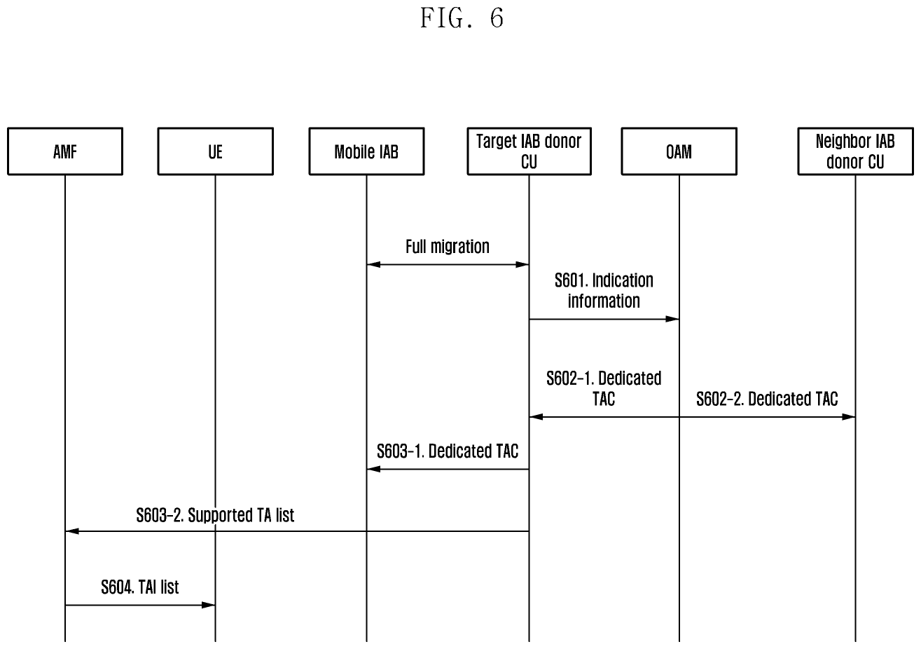

FIG. 6 is a flowchart illustrating an example of configuring a dedicated TAC for a cell of a mobile IAB node according to an embodiment of the present disclosure.

As shown in FIG. 6, the flow may include but not limited to at least one of the following steps:
1) In step 601, when the mobile IAB node is connected to a target IAB donor CU, the target IAB donor CU transmits first indication information for operation, admin-istration and maintenance (OAM).
a) The first indication information indicates the OAM to allocate a dedicated TAC within the range of the tracking area (TA) corresponding to the target IAB donor CU and nearby N (where, N is a positive integer) neighbor IAB donor CUs to the cell of the mobile IAB-DU.
2) In step S602, after receiving the first indication information, the OAM feeds back the dedicated TAC to the target IAB donor CU (step S602-1), and informs the nearby N neighbor IAB donor CUs to add the dedicated TAC to the supported TA list (step S602-2).
3) In step S603, the target IAB donor CU configures a dedicated TAC for the cell of the mobile IAB-DU (step S603-1), and sends the supported TA list (including the dedicated TAC) to the AMF (step S603-2).
4) In step S604, the AMF configures a TAI list for the UE served by the mobile IAB-DU cell, and the TAI list includes the dedicated TAC.

Optionally, the target IAB donor CU may receive candidate tracking area related information configured by the OAM, and determine the tracking area related information according to the candidate tracking area related information. For example, the OAM pre-allocates multiple dedicated TACs to the target IAB donor CU. When the mobile IAB accesses the target IAB donor CU, the target IAB donor CU selects one of the multiple TACs to configure for the mobile IAB node, and informs the OAM of the selected TAC, and the OAM informs the neighbor IAB of the same.

In this exemplary embodiment, since the TAI list configured by the AMF to the UE includes a dedicated TAC, when the mobile IAB node moves within a certain area, the UE can always detect the dedicated TAC in the TAC broadcast by the cell; and since the dedicated TAC is in the TAI list, the UE will not perform TAU, thereby reducing corresponding signalling overhead.

According to another embodiment of the present disclosure, the mobile IAB node may transmit indication information to the UE. In an exemplary embodiment, the UE can determine whether it is a UE of the first type. For example, the UE of the first type is an onboard UE (which may be a UE located on a vehicle such as a car or a train, etc. or a UE located near and in communication with a vehicle). In this case, the mobile IAB node can transmit indication information to the UE. The purpose of transmitting the indication information is to prevent the onboard UE from performing TAU. At this time, the corresponding signalling overhead can also be reduced.

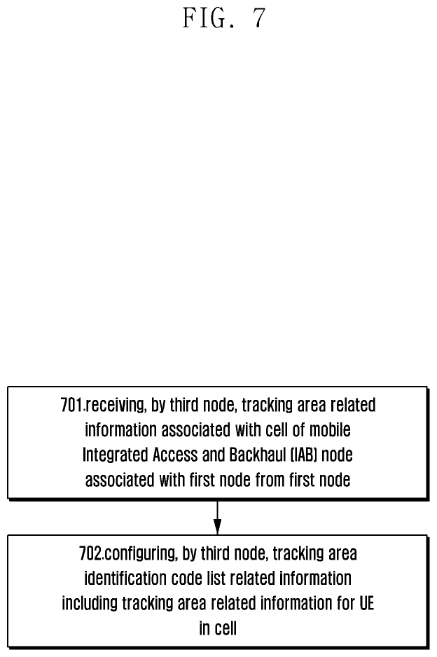

FIG. 7 is a diagram illustrating another example of a method for tracking area update in a wireless communication system according to an embodiment of the present disclosure.

According to an exemplary embodiment, the first node may be a target IAB donor, the second node may be an OAM, and the third node may be an AMF. However, these are just examples, and the first to third nodes here are not limited thereto.

As shown in FIG. 7, the method may include but not limited to at least one of the following steps:

In step 701, the third node receives tracking area related information associated with a cell of a mobile integrated access and backhaul (IAB) node associated with the first node from the first node.

In step 702, the third node transmits tracking area identification code list related information including the tracking area related information to user equipment (UE) of the cell.

In this embodiment, the third node receives the tracking area related information associated with the cell of the mobile IAB node associated with the first node from the first node, and transmits tracking area identification code list related information including the tracking area related information to the UE of the cell. Therefore, when the mobile IAB node moves within a certain area, the UE can always detect the tracking area related information in the TAC broadcast by the cell, and the tracking area related information is in the tracking area identification code list related information, so the UE will not perform TAU, thereby reducing the corresponding signalling overhead.

The following describes an example of a mobile IAB node transmitting indication information to a UE according to an embodiment of the present disclosure. According to an exemplary embodiment, the first node may be a target IAB donor, the second node may be an OAM, the third node may be an AMF, and the fourth node may be a source IAB donor. However, these are just examples, and the first to fourth nodes here are not limited thereto.

In an exemplary embodiment, there is provided a method performed by a first node in a wireless communication system. The method may include: receiving, by the first node, migration request related information from a fourth node to which a mobile integrated access and backhaul (IAB) node is connected; in response to the migration request related information, transmitting, by the first node, migration response related information to the fourth node; and transmitting, by the first node, tracking area update (TAU) related information to the mobile IAB node, wherein, the TAU related information includes information indicating not to perform TAU.

In an exemplary embodiment, there is provided a method performed by a mobile integrated access and backhaul (IAB) node in a wireless communication system. The method may include: receiving, by the mobile IAB node, tracking area update (TAU) related information from a first node, wherein, the TAU related information includes information indicating not to perform TAU; and transmitting, by the mobile IAB node, the TAU related information to a user equipment (UE).

In an exemplary embodiment, there is provided a method performed by a user equipment (UE) in a wireless communication system. The method may include: receiving, by the UE, tracking area update (TAU) related information from a mobile integrated access and backhaul (IAB) node, wherein, the TAU related information includes information indicating not to perform TAU; and not performing TAU by the UE, based on the TAU related information.

The mobile IAB migrates to a new target IAB donor CU, causing the target IAB donor CU to be reconfigured for the mobile IAB-DU, and the TAC broadcast by the mobile IAB-DU has changed. The following specific embodiments are provided so that the UE does not perform TAU, thereby reducing signalling overhead.

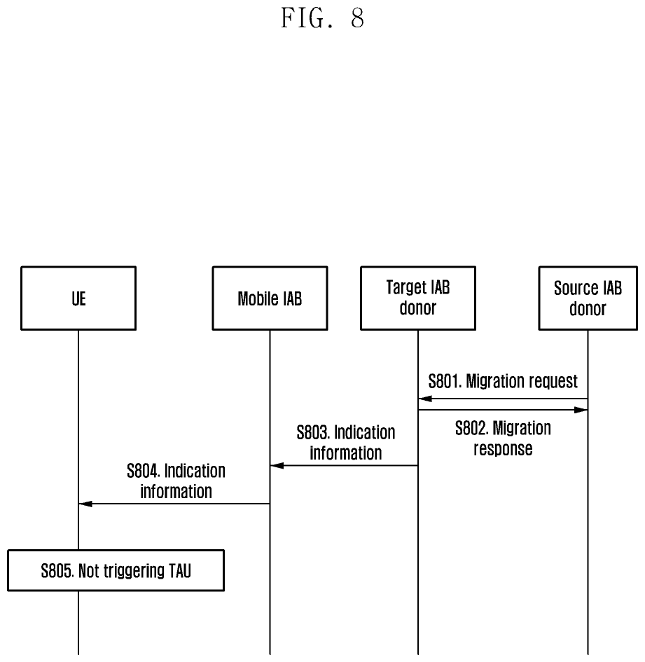

FIG. 8 is a flowchart illustrating an example of a mobile IAB node transmitting indication information to a UE according to an embodiment of the present disclosure. As shown in FIG. 8, the flow may include but not limited to at least one of the following steps:

In step S801, the target IAB donor CU receives a migration request from the source IAB donor CU to which the mobile IAB is connected;

In step S802, the target IAB donor CU sends a migration response to the source IAB donor CU; and

In step S803, after the mobile IAB node migrates to the target IAB donor CU, the target IAB donor CU transmits second indication information to the mobile IAB-CU.

When the mobile IAB-CU node receives the second indication information from the target IAB donor CU, the following operations are performed.

In step S804, the mobile IAB-CU node transmits the second indication information to the UE.
a) The second indication information can be carried in a SIB message, the second indication information can indicate one type of UE, and the SIB message includes the information indicating not to perform tracking area update; optionally, it may also include type information of UE that does not perform TAU, for example, onboard UE or other UE types.
b) The second indication information may also be carried in a DL RRC message, where the second indication information indicates a certain UE.

In step S805, the UE does not perform TAU after receiving the second indication information.
a) The second indication information may indicate RRC-connected UE, or RRC-idle UE, or all onboard UEs will not perform TAU after receiving the second indication information;
b) After receiving the second indication information, the UE can remain in a state of not performing TAU; if the UE receives third indication information for indicating to resume TAU, it can resume a state of performing TAU;
c) A timer may also be carried in the second indication information, and the UE remains in a state of not performing TAU within the corresponding time of the timer.

For one or more new UEs that access the mobile IAB node later, if a new UE receives the TAC broadcast by the mobile IAB node and the TAC is not in the TAI list configured by the AMF, the new UE performs TAU; and after performing TAU, if the new UE receives the second indication information transmitted by the mobile IAB node, the new UE does not perform TAU either.

In this exemplary embodiment, when the mobile IAB node moves to the target IAB donor CU, the TAC broadcast by the cell of the mobile IAB-DU will change. However, the mobile IAB node can transmit indication information to the UE so that the onboard UE does not perform TAU, thereby reducing the corresponding signalling overhead.

Optionally, during the migration procedure in which the mobile IAB node migrates to the target IAB donor CU, the target IAB donor CU transmits the second indication information to the source IAB donor CU, and the source IAB donor CU transmits the second indication information to the mobile IAB node. Optionally, during the full migration process of the mobile IAB node, the mobile IAB node will send an F1 setup request to the target IAB donor CU to request migration of the mobile IAB-DU. At this time, the target IAB donor CU can transmit the second indication information to the mobile IAB node through an F1 setup response.

The following describes an example of the mobile IAB node/IAB donor CU transmitting indication information to the AMF according to an embodiment of the present disclosure. According to an exemplary embodiment, the first node may be a target IAB donor, the second node may be an OAM, the third node may be an AMF, the fourth node may be a source IAB donor, and the fifth node may be an AMF other than the third node. However, these are just examples, and the first to fifth nodes here are not limited thereto.

In an exemplary embodiment, there is provided a method performed by a third node in a wireless communication system. The method may include: receiving, by the third node, first-type user equipment (UE) list related information from a first node; and sending, by the third node, a paging message for paging a UE in the first-type UE list related information to a mobile integrated access and backhaul (IAB) node.

If the mobile IAB node transmits the second indication information to the UE, the mobile IAB node/IAB donor CU can also inform the AMF of the relevant information, so as to facilitate the AMF paging the onboard UE served by the mobile IAB node.

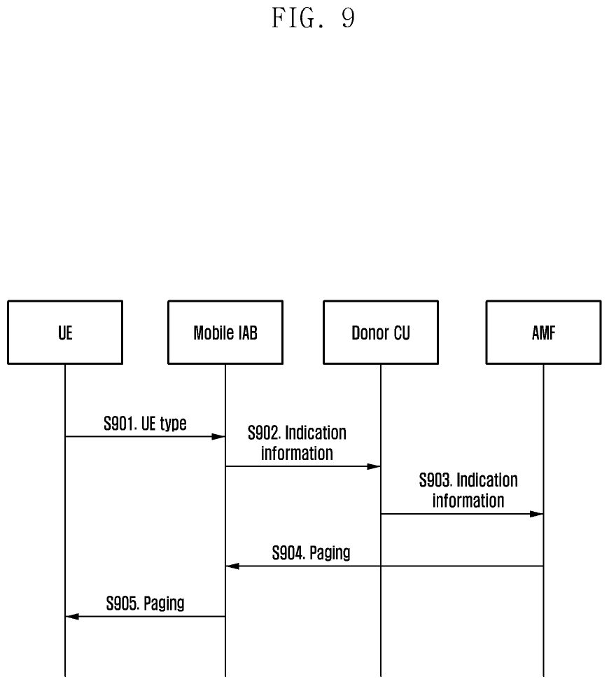

FIG. 9 is a flowchart illustrating an example of a mobile IAB node/IAB donor CU [129] transmitting indication information to an AMF according to an embodiment of the present disclosure.

As shown in FIG. 9, the flow may include but not limited to at least one of the following steps:

In step S901, the UE informs the mobile IAB of the UE type; optionally, the type may be an onboard UE, for example, the UE may inform the IAB of the UE type through a UE capability report or an uplink RRC message. In step S902, the mobile IAB node transmits third indication information to the IAB donor CU, indicating the IAB donor CU which UE has a bundling relationship with the mobile IAB (i.e., an onboard UE list).

a) Such UE does not need to perform TAU.

In step S903, the IAB donor CU transmits fourth indication information to the AMF, and content of the fourth indication information may be determined according to content of the third indication information.

a) Indication content of the fourth indication information is similar to that of the third indication information; a main difference is that the third indication information is transmitted through an Xn interface, while the fourth indication information is transmitted through an NG interface.

In step S904, when the AMF needs to page the UE in the list, it sends a paging message to the mobile IAB node.

In step S905, after receiving the paging message from the AMF, the mobile IAB node pages the UE in its cell.

According to an exemplary embodiment, the update of the onboard UE list may include at least one of the following ways:
a) For connected state UE
i. When the connected state UE performs handover (HO), the mobile IAB node knows that the UE is no longer an onboard UE, and will update the onboard UE list, and inform the AMF of the updated onboard UE list through the IAB donor CU.
b) For idle UE
i. When the idle UE is no longer an onboard UE, the mobile IAB node will not know this information;
ii. However, the idle UE knows that it is no longer an onboard UE, so it will not be restricted by the second indication information. If it finds that the TAC broadcast by the cell where it camps on is not in the TAI list configured by the AMF, it will initiate a TAU process;
iii. After the UE initiates the TAU process, the AMF can know that the UE is no longer in the onboard UE list. At this time, the AMF may update the onboard UE list and feed back the message that the UE is not in the onboard UE list, or the updated onboard UE list, to the mobile IAB node.

With this exemplary embodiment, at least the problem of updating the onboard UE list can be solved, so that the AMF can page the UE in the onboard UE list.

According to yet another embodiment of the present disclosure, there is another situation, that is, the mobile IAB node moves from one AMF to another AMF. At this time, the other AMF does not know the onboard UE list, so it cannot page the UE in the onboard UE list. Therefore, further enhancements are needed for this situation.

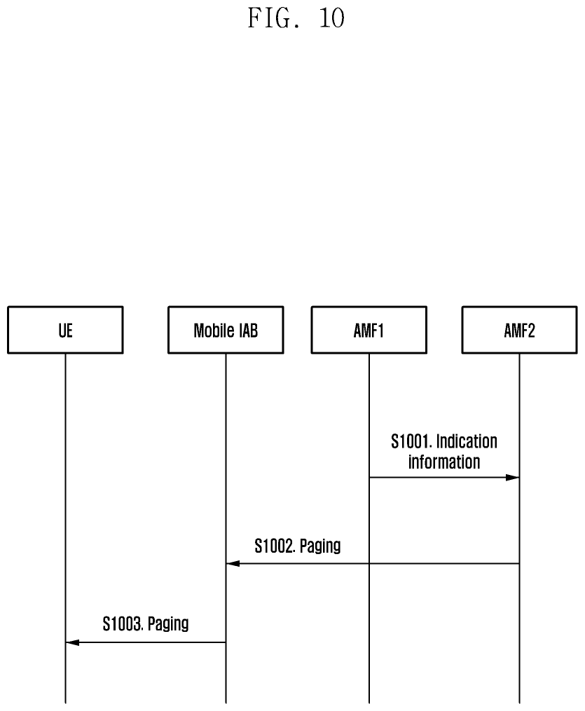

FIG. 10 is a flowchart illustrating an example in which an AMF informs another AMF of a list according to an embodiment of the present disclosure.

As shown in FIG. 10, the flow may include but not limited to at least one of the following steps:
1) In step S1001, when the mobile IAB node moves from AMF1 into the range of AMF2, AMF1 transmits fourth indication information to AMF2.
2) In step S1002, when AMF2 receives a message sent by AMF1, if the UE that needs to be paged is in the onboard UE list, then AMF2 sends a paging message to the mobile IAB node.
3) In step S1003, after receiving the paging message from AMF2, the mobile IAB pages the UE in its cell.

With this exemplary embodiment, at least the following advantageous effects can be achieved: when the mobile IAB node moves from one AMF to another AMF, even if the new AMF does not know the onboard UE list, it can also page the UE in the onboard UE list.

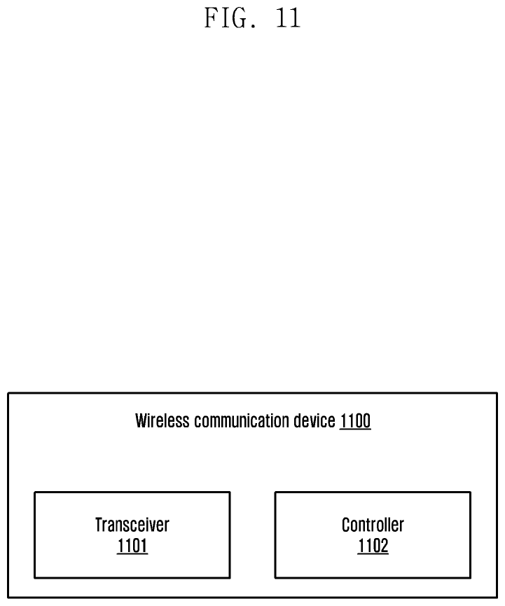

FIG. 11 is a block diagram illustrating a wireless communication device according to an embodiment of the present disclosure. The wireless communication device may also be referred to as a radio communication device, and may be any device in a wireless communication system, such as a user equipment, a base station, a core network, and the like. As shown in FIG. 11, a wireless communication device 1100 includes a transceiver 1101 and a controller 1102. Under the control of the controller 1102 (which may be implemented as one or more controllers), the wireless communication device 1100 may be configured to perform related operations performed by each wireless communication device in any of the methods described above. Although shown as separate entities, the transceiver 1110 and the controller 1120 may be implemented as a single entity, such as a single chip. The transceiver 1101 and the controller 1102 may be electrically connected or coupled to each other. The controller 1102 may be configured to execute the operations in the flow of any method described above, so as to control the overall operation of the wireless communication device 1100.

Those skilled in the art may realize that the present disclosure can be implemented in other specific forms without changing the technical idea or basic features of the present disclosure. Therefore, it should be understood that the above-mentioned embodiments are merely examples and not limitative. The scope of the present disclosure is defined by the appended claims rather than the detailed description. Therefore, it should be understood that all modifications or changes derived from the meaning and scope of the appended claims and their equivalents fall within the scope of the present disclosure.

In the above-described embodiments of the present disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the present disclosure has been illustrated and described with reference to various embodiments of the present disclosure, those skilled in the art will understand that various changes can be made in form and detail without departing from the spirit and scope of the present disclosure as defined by the appended claims and their equivalents.

1. A first node in a wireless communication system, the first node comprising:
a transceiver; and
a controller configured to:
receive, from a fourth node, migration request related information, wherein the fourth node is connected to a mobile integrated access and backhaul (IAB) node;
in response to the migration request related information, transmit, to the fourth node, migration response related information; and
transmit, to the mobile IAB node, tracking area update (TAU) related information, wherein the TAU related information comprises information indicating not to perform TAU.

2. The first node of claim 1, wherein the controller is further configured to:
receive, from the mobile IAB node, first-type user equipment (UE) list related information associated with the mobile IAB node; and
transmit, to a third node, the first-type UE list related information.

3. A method performed by a mobile integrated access and backhaul (IAB) node in a wireless communication system, the method comprising:
receiving, from a first node, tracking area update (TAU) related information, wherein the TAU related information comprises information indicating not to perform TAU; and
transmitting, to a user equipment (UE), the TAU related information.

4. The method of claim 3, wherein,
the TAU related information is carried in a system information block (SIB), and the TAU related information further comprises type-related information of UE that does not perform TAU; or
the TAU related information is carried in a radio resource control (RRC) message.

5. The method of claim 3, wherein,
the TAU related information further comprises a timer, and the UE does not perform TAU within time of the timer.

6. The method of claim 3, further comprising:
transmitting, to the first node, first-type UE list related information associated with the mobile IAB node.

7. The method of claim 6, further comprising:
updating, the mobile IAB node, the first-type UE list related information, and
transmitting the updated first-type UE list related information to a third node via the first node.

8. The method of claim 7, further comprising:
updating the first-type UE list related information wherein in case that the UE in a connected state is not a UE of a first type.

9. The method of claim 6, further comprising:
receiving, from a third node or other nodes in communication with the third node, a paging message for paging a UE in the first-type UE list related information; and
transmitting, to the UE, the paging message.

10-12. (canceled)

13. A mobile integrated access and backhaul (IAB) node in a wireless communication system, the mobile IAB node comprising:
a transceiver; and
a controller configured to:
receive, from a first node, tracking area update (TAU) related information, wherein the TAU related information comprises information indicating not to perform TAU; and
transmitting, to a user equipment (UE), the TAU related information.

14. (canceled)

15. The mobile IAB node of claim 13,
wherein, the TAU related information is carried in a system information block (SIB), and the TAU related information further comprises type-related information of UE that does not perform TAU; or
wherein the TAU related information is carried in a radio resource control (RRC) message.

16. The mobile IAB node of claim 13,
wherein the TAU related information further comprises a timer, and the UE does not perform TAU within time of the timer.

17. The mobile IAB node of claim 13,
wherein the controller is further configured to:
transmit, to the first node, first-type UE list related information associated with the mobile IAB node.

18. The mobile IAB node of claim 17,
wherein the controller is further configured to:
update, the mobile IAB node, the first-type UE list related information, and
transmit the updated first-type UE list related information to a third node via the first node.

19. The mobile IAB node of claim 18,
wherein the controller is further configured to:
update the first-type UE list related information wherein in case that the UE in a connected state is not a UE of a first type.

20. The mobile IAB node of claim 17,
wherein the controller is further configured to:
receive, from a third node or other nodes in communication with the third node, a paging message for paging a UE in the first-type UE list related information; and
transmit, to the UE, the paging message.
